(19) United States
(12) Patent Application Publication
(10) Pub. No.: US 2020/0244647 A1
(43) Pub. Date: Jul. 30, 2020

(54) Systems and Methods for Secure Management and Real-Time Diagnostics of Network Devices

(71) Applicant: Senao Networks, Inc., Taoyuan City (TW)

(72) Inventors: Pei Chuan Liu, Taipei (TW); Pin Chieh Yeh, Taoyuan (TW)

(21) Appl. No.: 16/699,913

(22) Filed: Dec. 2, 2019

(30) Foreign Application Priority Data
Jan. 29, 2019 (TW) 108103399
Jan. 29, 2019 (TW) 108103400

(51) Int. Cl. H04L 29/06; H04L 9/08; H04L 9/32

(52) U.S. Cl. CPC H04L 63/0823; H04L 9/0891; H04L 2463/082; H04L 9/3228; H04L 9/3268

(57) ABSTRACT

A cloud management system and methods for operating the same provide for management of large deployments of networked devices and Internet of Things devices. The system provides multi-factor authentication of devices by the use of both permanent digital certificates installed in devices at time of manufacture and temporary cryptographic keys that may be revoked or changed as needed. The system collects and provides status information from devices periodically on an automatically or user-adjustable interval, and when necessary, allows real-time status information to be collected, such as for diagnostics and troubleshooting

### RELATED APPLICATIONS

The present application claims the priority of Taiwan Patent Application No. 108103399, filed on Jan. 29, 2019, the disclosure of which is hereby incorporated by reference herein.

The present application claims the priority of Taiwan Patent Application No. 108103400, filed on Jan. 29, 2019, the disclosure of which is hereby incorporated by reference herein.

### FIELD OF THE INVENTION

The present invention relates to systems and methods for securely managing network devices and for performing real-time diagnostics on those devices. The systems and methods described herein may be particularly useful in environments with a very large deployment of devices, such as across a large enterprise, multiple enterprises, or even worldwide, such as a worldwide deployment of Internet of Things devices.

### BACKGROUND OF THE INVENTION

There is a need to manage devices over the cloud. As networked devices proliferate on the Internet, particularly with the advent of the Internet of Things, it is ever more important to be able to manage ever more devices, do so securely, and to see their real-time status. It is especially important to be able to access all these functions over the cloud where devices are numerous and dispersed geographically and across different networks.

For example, a company may deploy a large number of devices across its enterprise, including network infrastructure devices such as gateways, routers, switches, and access points, as well as end devices including VoIP phones, security cameras, and various kinds of sensors. The types and number of such devices are only expected to increase going forward. It would be useful for a company like this to be able to manage its devices from a single interface that is secure and provides real-time status.

For a vendor of networked devices, it would be useful for it to be able to manage all of its deployed devices no matter where the devices have been sold or used. For instance, a vendor of networked device is likely to have its devices in use by many different unrelated companies. A cloud-based management system would allow device vendors to provide to their customers management services for its networked devices.

A number of challenges exist in the management of very large deployments of networked devices. One issue pertaining to security is the need to ensure that devices under management are legitimate and authorized to be connected to the management system. A malicious device connected to the management may be able to compromise the management system and potentially the other devices under management by the system.

Another challenge that occurs in a management system for a very large deployment of devices is the need to provide real-time data for diagnostics without hindering overall performance of the management system. Enabling a very large deployment of devices to communicate in real-time with a management system can be extremely burdensome on the management system. This can degrade system and/or network performance. However, there are situations in which real-time communications would be needed, such as during troubleshooting or diagnostics of particular devices.

A need therefore exists for systems and methods for securely managing network devices and for performing real-time diagnostics on those devices in an efficient manner.

### SUMMARY OF THE INVENTION

The present invention provides a cloud-based management system, and methods for operating such, that allow networked devices to be managed in a secure fashion and in real-time in an efficient manner.

In some embodiments of the invention, a cloud-based management system provides multi-factor authentication of networked devices without user intervention, including by authenticating a device's digital certificate, burned in at time of manufacture, and upon successful authentication of such digital certificate, to provide a cryptographic secret key to the device for use in further communications with the management system.

In some embodiment of the invention, a cloud-based management system provides real-time command capabilities to networked devices under management, as well as a combination of both historical and real-time status information for the devices. The real-time status information may be provided by the management system as needed to allow troubleshooting of a device.

### BRIEF DESCRIPTION OF THE DRAWINGS

Other objects and advantages of the present invention will become apparent to those skilled in the art upon reading the following detailed description and upon reference to the drawings in which:

FIG. 1 is a schematic diagram of the architecture of a prior art cloud system.

FIG. 2. is a schematic diagram of a cloud management system as an embodiment of the present disclosure.

FIG. 3 is a flowchart illustrating the multi-factor authentication of managed devices on the cloud management system.

### DETAILED DESCRIPTION OF THE INVENTION

It should be understood that while this invention has been described in connection with particular examples thereof, no limitation is intended thereby since obvious modifications will become apparent to those skilled in the art after having the benefit of studying this disclosure.

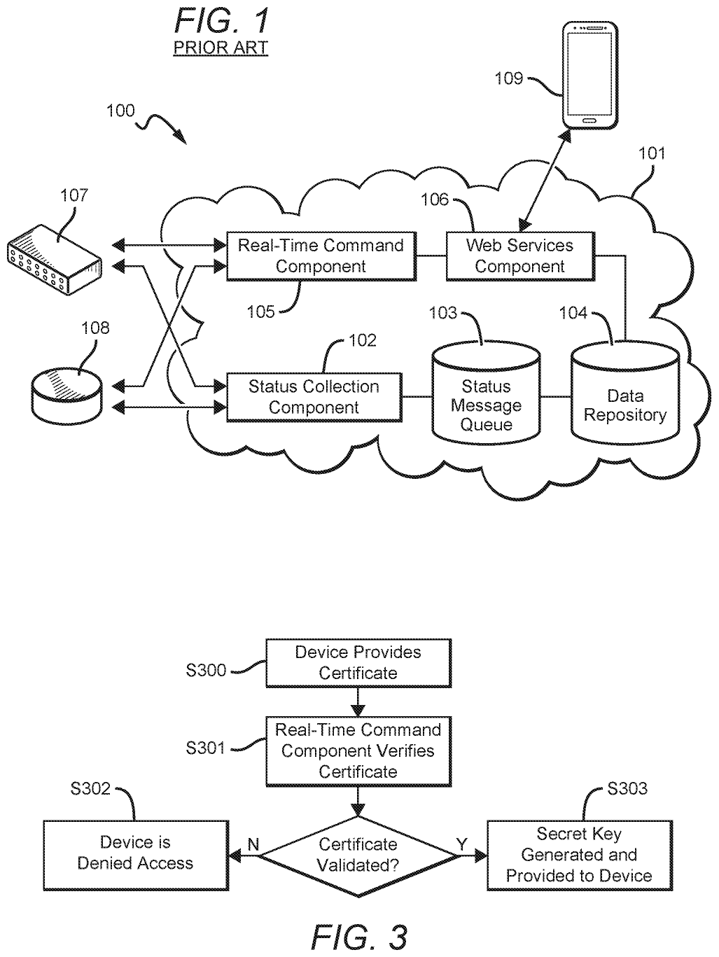

FIG. 1 depicts a prior art cloud management system 100. The system may be implemented on a cloud platform 101, and comprises a status collection component 102, a status message queue 103, a data repository 104, a real-time command component 105, and a web services component 106. The cloud management system 100 provides for the management of a number of network devices, including, as depicted here, network switch 107 and wireless access point 108. Cloud management system 100 may be made available to users over a network, such as a local area network, a wide area network, or the Internet. A user is able to access the cloud management system 100 by using a client application 109, which may be implemented as a browser app or as a native app for various operating systems.

When a new device such as switch 107 or access point 108 is turned on and connected to the network for the first time, it attempts to authenticate itself with cloud management system 100 by transmitting a digital certificate to the real-time command component 105. Each device includes a unique digital certificate baked in at time of manufacture. In theory, the digital certificate should be stored in a secure area on the device and encrypted when it is needed to be transmitted, such as to the cloud management system 100. That is, a user should not be able to access a device's digital certificate. Upon receipt of the device's digital certificate, the real-time command component attempts to validate it, either by itself or in conjunction with other components such as a certificate authority (not shown).

Upon validation of the digital certificate, a trusted communications pipeline is set up between the new device and the cloud management system. Once this happens, the new device 107 or 108 may report its status to status collection component 102. Each device reports its status to status collection component 102 on a periodic basis, such as every five minutes. The periodic nature of the reporting and collection of status information avoids overburdening the devices and especially the cloud management system 100, as compared to, for instance, doing so on a continuous basis. The time intervals for status reporting can be set by the system administrator to balance the need for relatively current information and to avoid overburdening the systems. The status information collected by status collection component 102 is initially stored in a status message queue 103. Because there may be a high volume of status messages, which depends on factors such as the number of devices under management, the types of messages being sent, and the time intervals on which such messages are sent, status message queue 103 may be implemented in a simple database in main memory or as flat files. The status information may be further processed, and processed versions of the status information may be stored in a data repository 104. Data repository 104 may be implemented as a more robust database that allows for more complex data operations, such as a SQL or other relational database.

Web services component 106 allows various data and management functions of cloud management system 100 to be exposed to a client application 109 operated by an end user. For instance, web services component 106 may communicate using standard web protocols to browser-based client applications or native specialized client applications compiled for particular operating systems and devices. The client application 109 may present the status information from managed devices 107 and 108 in various ways to the user. The web services component may be configured to obtain the status information from data repository 104 and to provide it to the client application 109.

Web services component 106 also provides management capabilities to client application 109. For instance, client application 109 may allow a user to change the configurations of devices 107 and 108, update their firmware, apply security patches, or reboot them. Web services components 106 communicates with the real-time command component 105 to push commands instantaneously to devices 107 and 108.

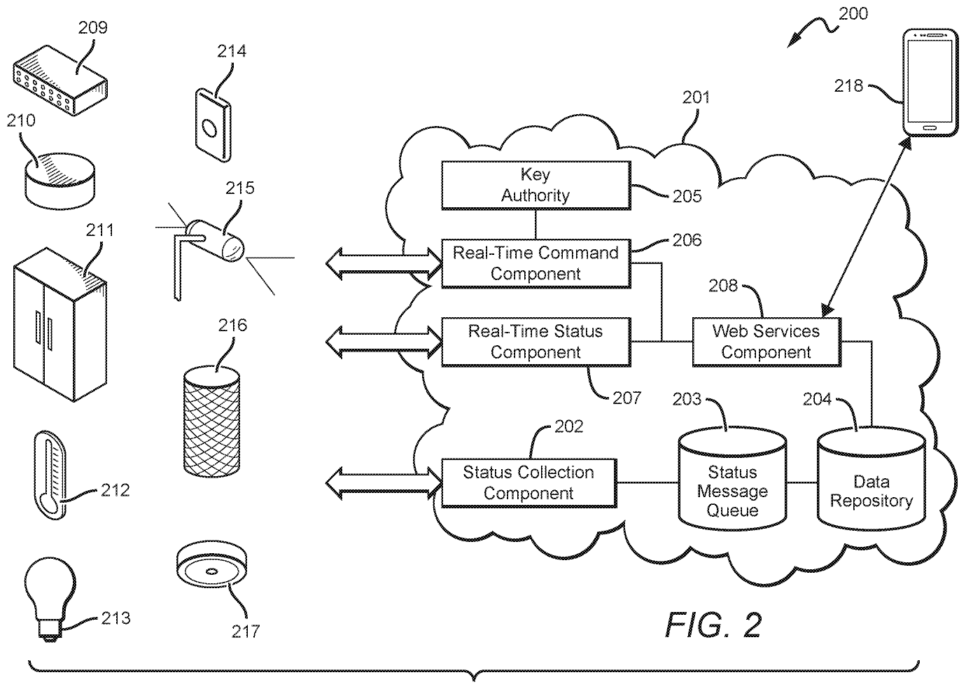

FIG. 2 depicts a cloud management system 200 that improves on the prior art cloud management system. The system may be implemented on a cloud platform 201, and comprises a status collection component 202, a status message queue 203, a data repository 204, a key authority 205, a real-time command component 206, a real-time status component 207, and a web services component 208. In some embodiments, the real-time status component 207 may provide a Web Socket service in accordance with the Web Application Messaging Protocol, allowing a data client to register to receive existing data streams or to create new data streams. In some embodiments, the web services component 208 may conform to a REST architectural style and communicate using RESTful APIs.

The cloud management system 200 is able to manage any type of network devices and Internet of Things devices, including, by way of example as depicted here, network switch 209, wireless access point 210, kitchen appliance 211, thermometer 212, lightbulb 213, doorbell 214, security camera 215, air quality sensor 216, and smoke and carbon monoxide detector 217. Cloud management system 200 may be made available to users over the Internet or other network. A user is able to access the cloud management system 100 by using a client application 218, which may be implemented as a browser app or as a native app for various operating systems.

Cloud management system 200 is able to securely manage and provide for critical real-time diagnostics for a vast number of devices as further described in this disclosure. For instance, cloud management system 200 may be operated by an organization to efficiently manage its entire deployment of networked devices through a unified management system and interface. Alternatively, cloud management system 200 may be operated by a device vendor or other third party, and access to the system could be sold to organizations and individual end users.

### Multi-Factor Authentication

In a traditional cloud management system, such as system 100 depicted in FIG. 1, a device is authenticated by the system based on a digital certificate baked into the device at the factory. This system is not tamper-proof, however. Although it is a known best practice to maintain the certificate in encrypted form in a secure area of a device, it may not be the case that all device makers would employ perfect or even adequate security practices. A dedicated attacker could potentially extract the certificate from a device and use it with an unauthorized device to gain access to the cloud management system. Alternatively, it may be the case that the certificate is not compromised, but that the firmware or software of a device are maliciously modified to pose a danger to the cloud management system. In the prior art system that relies on the digital certificate as the sole or main factor for authentication, it may be difficult to detect a malicious actor who has access to a certificate that appears to be valid.

Cloud management system 200 provides for multi-factor authentication of devices under management and does so without user intervention. FIG. 3 depicts a flow chart setting forth the steps of an embodiment of this multi-factor authentication process. In step S300, when a device, such as any of devices 209-217, is powered on for the first time, it attempts to authenticate itself on cloud management system 200 by providing its digital certificate to the system. The certificate may be transmitted to the real-time command component 206. In step S301, the real-time command component 206 attempts to validate the digital certificate. It may do so by accessing a database of valid certificates and/or calling an independent certificate authority separate from the cloud management system 200. For instance, the cloud management system 200 may validate certificates with different independent certificate authorities depending on the type or manufacturer of the device or other criteria associated with the device. The certificate authority may also be a centralized platform or broker of validation information and logic from multiple sources.

The validation of a certificate may take multiple criteria into account. As one example, the real-time command component 206 may perform an initial validation of the certificate before passing the certificate along to a certification authority, such as checking that there is not already a device under management having the same certificate and that the certificate is in the correct format and within the correct range for the particular type and manufacturer of the device. The certificate can also be cross checked against a list of revoked certificates, either stored in cloud management system 200 or on an external service accessed via an application programming interface.

After step S301, the processing of the device seeking to connect to cloud management system 200 diverges based on whether the certificate was validated. If the certificate was not validated, the process moves on to step S302, in which the device is denied from connecting to cloud management system 200. Information associated with the device may be placed on a banned devices database to ensure that any future attempt by the device to connect would be automatically rejected. Such information may include the network addresses used by the device, the location of the device, and any other information that may be helpful to identifying the device or similar devices in the future. For additional security, the digital certificate itself may be revoked so that even the original device bearing the certificate would no longer be able to access the cloud management system.

If the certificate is validated, however, the process moves on to step S303, in which a secret key is generated by key authority 205 and provided to the device. The key may be an HMAC or a hash-based message authentication code or another type of cryptographically derived code. The networked device and cloud management system 200 may thereafter use the key to communicate with each other.

The above-described process does not require user invention and in fact may be transparent to the user, but for additional security, a user may be prompted to take action to incorporate additional randomness into the key generation process, such as by entering a string of characters or allowing biometric readings to be taken of the user.

The use of the cryptographic key as a second factor in authentication provides additional security for cloud management system 200 because it is no longer sufficient for an attacker to compromise the digital certificate of a device. The attacker must also compromise the cryptographic key, which is impractical because key generation and provisioning is a centrally managed function by cloud management system 200. This guards against, among other things, poor security practices by a device manufacturer in safeguarding the digital certificate. Moreover, the key can be revoked or changed at any time by cloud management system 200. The system can be set to revoke keys based on random intervals or fixed intervals of different lengths

### Real-Time Diagnostics

The traditional cloud management system 100 depicted in FIG. 1 is unable to provide real-time status information on managed devices in a practical way, especially if there is a large number of devices under management. In the traditional system, the devices report status to the status collection component 102 on a periodic basis to avoid overwhelming the cloud management system. If all managed devices continuously transmitted status information to the cloud management system, it may tax the system to such an extent that its performance is compromised. In the event that the cloud management system is hosted on a public cloud service, the service provider may charge a fee based on the volume of usage of the cloud service. In such a situation, having managed devices send status messages on a continuous basis directly impacts the bottom line. Moreover, there is no value to be gained in most cases for having exactly real-time status information. In most cases, it is adequate to have information that is recent but not real-time.

Notwithstanding the foregoing, there are situations in which it is necessary or at least highly desirable to have real-time status information from managed devices, such as to perform diagnostics and troubleshooting when a device is not behaving as expected. The cloud management system 200 depicted in FIG. 2 provides a solution for this need. In cloud management system 200, the real-time status component 207 is able to open a direct connection to a managed device by using a Web Socket or similar technology. When such a connection is established, the managed device is able to provide real-time status information to the real-time status component 207 and therefore to cloud management system 200.

A key feature of cloud management system 200 is that real-time status reporting is provided only as needed to the managed devices. In most operational scenarios, the managed devices would continue to provide status on a periodic basis as described above. However, by analyzing the collected status information of the managed devices, the cloud management system 200 may detect unexpected or historically anomalous behavior from one or more devices. In such situations, the cloud management system 200 may instruct the real-time command component 206 to transmit a command to a device to increase the frequency of its status reporting or to deploy the real-time status component 207 to activate the real-time status reporting of the managed devices. Alternatively, a user such as a system administrator or IT managed services provider can use the client application 109 to select specific managed devices for real-time reporting.

It will be appreciated that because the cloud management system 200 provides for user or dynamically adjustable intervals for status reporting by devices as well as real-time reporting when needed, the system is able to manage a large deployment of devices from the cloud in an effective and cost-effective way. This system allows a device vendor or other third-party provider to manage multiple organizations' devices remotely. It also allows a device vendor to provide value added managed services subsequent to the sale of a device.

### Real-Time Messages With Push-Subscription Model

A challenge that has arisen in connection with cloud management systems in general is known as the NAT-traversal issue. Typically, managed network devices obtain only an internal IP using DHCP and run inside a private local area network (LAN). Oftentimes, only a small number of public IP addresses, perhaps even just one, are exposed to the wider Internet for multiple devices on a private LAN. Network address translation (NAT) is used to allow devices on the private LAN to communicate with other devices on the Internet. In this typical network configuration, applications such as external cloud management services cannot directly access a managed device on a private LAN without additional TCP/IP port mapping settings made in the router of the private LAN. However, having to set port mapping for each device is impractical, particularly where the number of devices under management is large. This makes it practically infeasible for a cloud management system to request and obtain status information from and otherwise manage anything bigger than a trivially small population of networked devices.

The system described herein avoids the issues described above. The system provides real-time diagnostics information for managed devices using a push-subscription model. Because the system uses a real-time command component 206 that maintains a real-time connection to all managed devices, a user application, such as an app or browser seeking diagnostics information, can first initiate a “subscription request” for certain diagnostics information for a device through web services 208. The subscription request is then passed on to the real-time status component 207. The real-time status component creates a “topic” for the requested information which operates as a data channel that may be subscribed to by user applications. The original requesting user application is automatically added as a subscriber to the topic channel. The subscription request is also passed to the real-time command component 206, which transmits a command to the device to engage in real-time monitoring. The device then subscribes to the corresponding topic channel in the real-time status component 207 and starts to continually push its status information—e.g., CPU or memory utilization, network performance, or the like—to the channel. That is, the managed device acts as a provider of data to the topic channel, while the user application seeking diagnostics information acts as a consumer of data from the topic channel.

After the topic channel is created in the real-time status component 207 and the managed device subscribes to the channel as a data provider, user applications can subscribe to the channel by connecting to the real-time status component 207 directly or through the web services component 208 as an intermediary. All data pushed by the managed device to the real-time status component 207 for a particular channel are then broadcast to the other subscribers of the channel.

The real-time status component 207 tracks the number of devices subscribing to the channel. User applications can unsubscribe from the channel, e.g., by providing an interface that allows a user to switch away from viewing real-time diagnostics. If the real-time status component 207 detects that the only device subscribed to a topic channel is the managed device itself, it will shut down the channel after certain a length of time, which can be adjusted to optimize performance.

In addition to avoiding the NAT-traversal issue, this push-subscription model has the advantage that it is scalable to managing a very large number of networked devices, such as across an entire enterprise or even across all customers of a vendor of networked devices. Because diagnostics information pushed by one managed device are then transmitted to multiple user applications, the alleviates the load on the managed device and on the real-time status component 207.

### Device Data Subscriptions and Example Use Cases

As already described elsewhere in this disclosure, cloud management system 200 is able to manage a wide variety of network devices, including both traditional networked devices such as switches and access points, but also home appliances and sensors and the like. Many of these devices have some common status data that they may report to cloud management system 200, such as those related to network performance. However, different types of devices may also have their own unique types of data to report and different types of actions that could be taken automatically or manually activated by a user based on the data.

For example, the cloud management system may manage a smoke and carbon monoxide detector 217. In additional to standard network performance-related status data, device 217 may provide status data related to its intended function. For example, it could be configured to transmit its smoke and carbon monoxide sensor readings to the cloud management system to enable alerts to be provided to a homeowner when she is away from home. Due to the nature of such a device, it may be set by default to report status on a relatively frequent basis. Cloud management system may be set up so that the frequency of such status reports could be selected by an end user and higher fees could be charged for higher frequencies. The device may also automatically switch to providing real-time status when it detects smoke or carbon monoxide in its environment. Different users may wish to receive different data from device 217. A homeowner or businessowner occupying the premises in which the device is installed may wish to receive status information regarding smoke and carbon monoxide levels, while an IT services provider or network administrator may be interested only in status data pertaining to network or device performance. The client application 109 can allow users to subscribe to particular data topics to be provided to avoid being overburdened with data.

The above-described embodiments are intended to be exemplary embodiments illustrating the principles of the present invention and are not intended to be limiting. Modifications and variations of the above-described embodiments can be made by those skilled in the art without departing from the spirit and scope of the invention.

We claim:

1. A system for managing a networked device, comprising:
a multi-factor authentication component configured to authenticate a networked device based on a combination of a permanent digital certificate and a temporary cryptographic key;
a status collection component configured to receive a first status information from the networked device on a periodic basis after it is authenticated;
a real-time status component capable of receiving a second status information from the networked device on a real-time basis;
a real-time command component capable of providing commands to the networked device on a real-time basis;
a web services component capable of providing the first status information and second status information to client applications; and
a client application capable of
receiving the first status information and second status information;
allowing a user to cause the transmission of a command by the real-time command component to the networked device to provide the second status information to the real-time status component; and
providing both the first status information and second status information to the user.

2. The system of claim 1, wherein the multi-factor authentication component is further configured to revoke the temporary cryptographic key on a periodic basis to cause the cloud management system to re-authenticate the networked device.

3. The system of claim 1, wherein the client application is further capable of allowing the end user to subscribe to a subset of data that may be provided by the networked device.

4. The system of claim 1, wherein the multi-factor authentication component is further configured to authenticate a plurality of networked devices from different manufacturers.

5. A system for managing a plurality of networked devices, comprising:
a multi-factor authentication component configured to authenticate a plurality of networked devices based on a combination of a permanent digital certificate and a temporary cryptographic key;
a status collection component configured to receive a first status information from the plurality of networked devices on a periodic basis after they are authenticated;
a real-time status component capable of receiving a second status information from any of the plurality of networked devices on a real-time basis;
a real-time command component capable of providing commands to the plurality of networked devices on a real-time basis;
a web services component capable of providing the first status information and second status information to client applications; and
a client application capable of
receiving the first status information and second status information;
allowing a user to cause the transmission of a command by the real-time command component to one or more of the plurality of networked devices to provide the second status information to the real-time status component; and
providing both the first status information and second status information to the user.

6. The system of claim 5, wherein the multi-factor authentication component is further configured to revoke the temporary cryptographic keys on a periodic basis to cause the cloud management system to re-authenticate the plurality of networked devices.

7. The system of claim 5, wherein the client application is further capable of allowing the end user to subscribe to a subset of data that may be provided by one of the plurality of networked devices.

8. The system of claim 5, wherein the plurality of networked devices are provided by a plurality of different manufacturers.

9. The system of claim 5, wherein
the client application is further capable of transmitting a first subscription request to the web services component, wherein the first subscription request is for a subset of data that may be provided by one of the plurality of networked devices;
the web services component is further capable of transmitting the first subscription request to the real-time status component;
the real-time status component is further capable of obtaining from the one of the plurality of network devices the data for the first subscription request and transmitting the data to the web services component to be provided to the client application; and
further comprising a second client application capable of transmitting a second subscription request for the same data as the first subscription request.

10. A method for managing a plurality of networked devices, comprising the steps of:
authenticating a plurality of networked devices based on a combination of a permanent digital certificate and a temporary cryptographic key;
receiving a first status information from the plurality of networked devices on a periodic basis after they are authenticated;
commanding at least one of the plurality of networked devices to provide a second status information on a real-time basis;
receiving the second status information on a real-time basis; and
providing both the first status information and second status information to the user.

11. The method of claim 10, further comprising the steps of
revoking the temporary cryptographic keys on a periodic basis; and
re-authenticating the plurality of networked devices.

12. The method of claim 10, further comprising the step of providing a subset of data that may be provided by one of the plurality of networked devices based on the preference of the user.

13. The method of claim 10, wherein the plurality of networked devices are provided by a plurality of different manufacturers.
